(19) United States
(12) Patent Application Publication
(10) Pub. No.: US 2016/0203528 A1
(43) Pub. Date: Jul. 14, 2016

(54) METHOD AND SYSTEM THAT ALLOCATES VIRTUAL NETWORK COST IN A SOFTWARE-DEFINED DATA CENTER

(71) Applicant: VMWARE, INC., Palo Alto, CA (US)

(72) Inventors: MRITYUNJOY SAHA, Bangalore (IN); KUMAR GAURAV, Bangalore (IN)

(21) Appl. No.: 14/637,426

(22) Filed: Mar. 4, 2015

(30) Foreign Application Priority Data
Jan. 9, 2015 (IN) 164/CHE/2015

(51) Int. Cl. G06Q 30/04; H04L 12/26; H04L 12/911; G06F 9/455

(52) U.S. Cl. CPC G06Q 30/04; G06F 9/45558; H04L 43/08; H04L 47/822; G06F 2009/45595; G06F 2009/4557

(57) ABSTRACT

The present disclosure describes methods and systems that allocate costs of deploying and operating a virtual network to tenants that use the virtual network. In one implementation, costs are allocated to tenant virtual machines (“VMs”) by determining a network bandwidth of a virtual network, determining a common cost of operating the virtual network, determining a service capacity for each network service provided by the virtual network, and determining a service cost for each network service. A portion of the common cost is allocated to each VM based on the proportion of network bandwidth used by each VM, and a portion of the service cost is allocated to each VM based on the proportion of the service capacity used by each VM.

### RELATED APPLICATIONS

Benefit is claimed under 35 U.S.C. 119(a)-(d) to Foreign application Serial No. 164/CHE/2015 filed in India entitled “METHOD AND SYSTEM THAT ALLOCATES VIRTUAL NETWORK COST IN A SOFTWARE-DEFINED DATA CENTER”, on Jan. 9, 2015, by VMware, Inc., which is herein incorporated in its entirety by reference for all purposes.

### TECHNICAL FIELD

The present disclosure is directed to methods and systems that manage computer networks and, in particular, to methods and systems that manage the cost of virtual networks.

### BACKGROUND

Computer networks are complex communication networks that are able to interconnect a wide variety of network client devices, such as personal computers, mobile devices, tablets, wearable technologies, and computer servers. The structure of computer networks is often described in the context of the Open Systems Interconnection (“OSI”) model. The OSI model defines of seven levels of network functionality. The lowest level of the OSI model, level 1, corresponds to the physical connections that make up a network. Level 2 and level 3 describe packet switching and packet routing capabilities. Levels 4-7 of the OSI model describe higher levels of functionality that are increasingly abstracted from the physical structure of the network such as transport, session, and application services. Examples of level 4-7 network services include firewall services, load-balancing services, and web-page-serving services. As the number and variety of network client devices interconnected by a computer network increases, the complexity of the logical and physical network infrastructure also tends to increase. As a result, large physical networks generally require substantial maintenance, configuration, and support.

Virtual networks can address these problems by implementing logical network topologies with easy-to-manage virtual network appliances. In this way, the underlying physical network hardware can be constructed and maintained with a relatively flat, simple topology. For example, a virtual network server can define a multi-segment virtual network using virtual switches and virtual routers. The level-2 and level-3 structure of the virtual network can then be modified without moving, without reconnecting physical network switches and client connections, and without reconfiguring. Through the use of virtual networks, the underlying physical network structure can be relatively simple and flat and more complex logical network structures can be created and managed using virtual appliances. Many difficult support tasks associated with maintaining hardware-based switching, routing, firewall, and security services can be accomplished by moving the associated network services to a virtual network and then maintaining those services within the virtual network. However, in a virtual data center, allocating the costs of operating a virtual network to data center tenants may be challenging.

### SUMMARY OF THE DISCLOSURE

The present disclosure describes methods and systems that allocate costs associated with deploying and operating a virtual network to tenants that use the virtual network. In one implementation, costs are allocated to tenant virtual machines (“VMs”) by determining a network bandwidth of a virtual network, determining a common cost associated with operating the virtual network, determining a service capacity for each network service provided by the virtual network, and determining a service cost for each network service. A portion of the common cost is allocated to each VM based on the proportion of network bandwidth used by each VM, and a portion of the service cost is allocated to each VM based on the proportion of the service capacity used by each VM.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing.

FIG. 4 illustrates generalized hardware and software components of a general-purpose compute system, such as a general-purpose computer system having an architecture similar to that shown in FIG. 1.

FIG. 5 illustrates one type of virtual machine and virtual-machine execution environment.

FIG. 6 illustrates an OVF package.

FIG. 7 illustrates virtual data centers provided as an abstraction of underlying physical-data-center hardware components.

FIG. 8 illustrates virtual-machine components of a virtual-data-center management server and physical servers of a physical data center above which a virtual-data-center interface is provided by the virtual-data-center management server.

FIG. 9 illustrates a cloud-director level of abstraction.

FIG. 10 illustrates virtual-cloud-connector nodes.

FIG. 11 illustrates a data center having multiple computing systems.

FIG. 12 illustrates a computer network with a variety of interconnected network client devices.

FIG. 13 illustrates a variety of networked client devices and client networks that are connected to a virtual network provider.

FIG. 14 illustrates one possible virtual network structure that can be configured by the virtual network provider.

FIG. 15 illustrates physical networking hardware and physical servers configured with virtual network platform software that provides virtual networking services

FIG. 16 illustrates various network services and network functions that may be provided by a virtual network platform.

FIG. 17 illustrates a flow diagram that allocates costs of a virtual network based on VM utilization of the virtual network.

FIG. 18 illustrates a flow diagram of the routine “Determine Costs of a Virtual Network” called in FIG. 17.

FIG. 19 illustrates a flow diagram of the routine “Determine Bandwidth and Service Capacities of the Virtual Network” called in FIG. 17

FIG. 20 illustrates a flow diagram of the routine “Allocate Virtual Network Costs” called in FIG. 17

FIG. 21 illustrates a flow diagram of the routine “Allocate the Virtual Network's Costs to the Tenant VMs” called in FIG. 17

FIG. 22 illustrates a flow diagram that adjusts resources of a virtual network.

FIG. 23 illustrates a flow diagram of the routine “Determine Unallocated Costs” called FIG. 22.

FIG. 24 illustrates a flow diagram of the routine “Adjust Resources Allocated to the Virtual Network” called in FIG. 22.

### DETAILED DESCRIPTION

The present disclosure describes methods and systems that allocate costs associated with deploying and operating a virtual network to tenant VMs that use the virtual network. Virtual networks can be created using a combination of hardware-based network appliances and virtual network appliances. Virtual network appliances are created through the use of a virtual network platform. In some implementations, the virtual network platform runs on one physical computer server, and in other implementations, the virtual network platform runs on multiple physical computer servers that are interconnected over a physical network. The virtual network platform can provide virtual network services that include level-2 switching, level-3 routing, and level 4-7 network services. In other implementations, even though certain portions of a virtual network are implemented in software, physical network client devices such as personal computers, mobile phones, tablet computers, and network printers connect to virtual networks and use virtual network services in the similar way that physical networks are used. In general, the network services provided by virtual networks are indistinguishable from similar services provided by traditional hardware-based networks.

Many virtual networks do not have distinguishable or separable hardware that can be associated with providing each particular networking service. As a consequence, identifying and assigning the costs of operating the virtual network to the tenants that use the virtual network can be difficult. The present document describes methods and systems that measure the costs of operating a virtual network, and further describes how these costs can be allocated to tenants that use the virtual network.

In order to describe the methods and systems to which the present disclosure is directed, the detailed-description section of the present disclosure includes four subsections: (1) an overview of computer architecture and virtual machines (“VMs”); (2) a discussion of virtual networks; (3) a discussion of methods and systems that measure and allocate virtual networking costs; and (4) an example that illustrates the operation of the above methods.

### An Overview of Computer Architecture and VMs

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

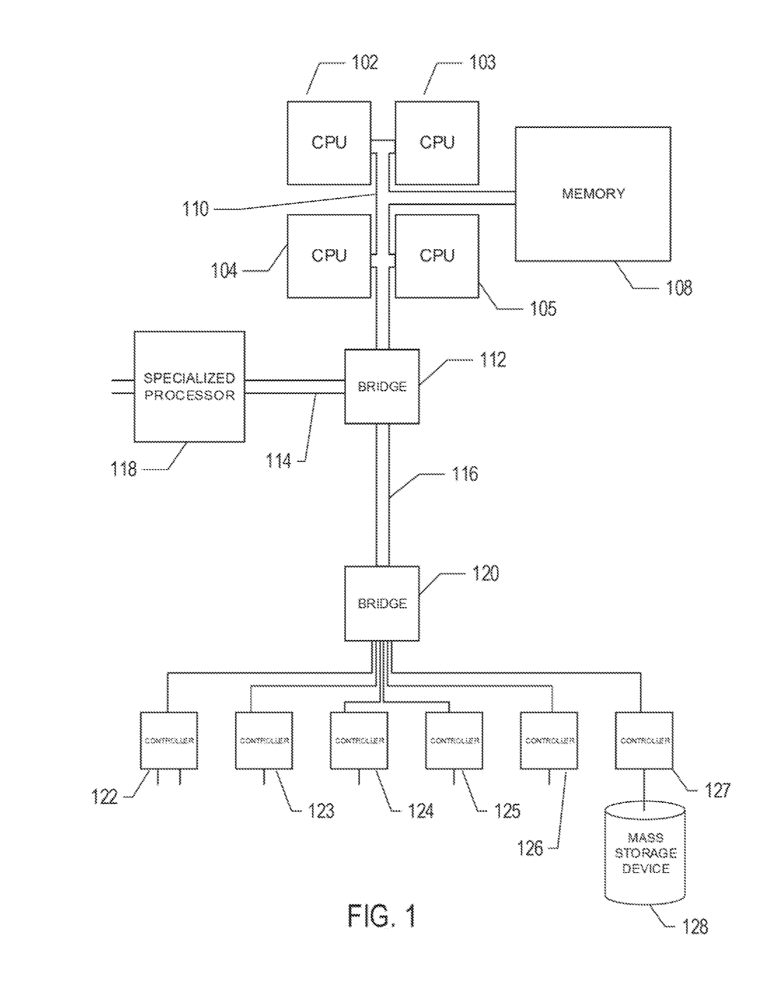

FIG. 1 shows a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

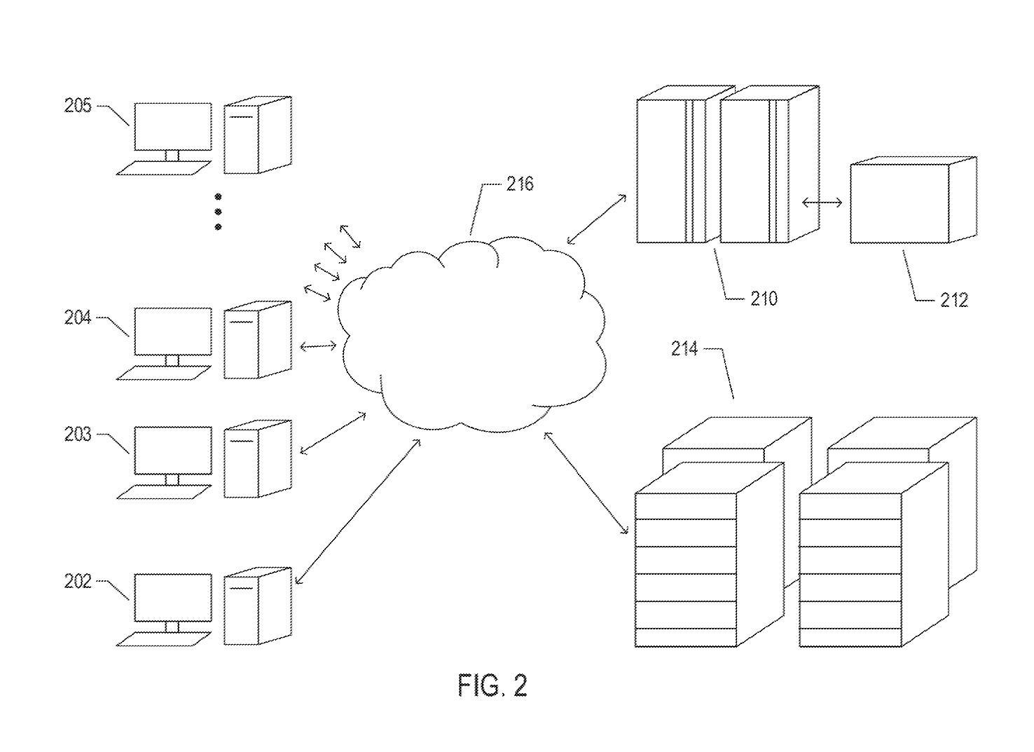

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

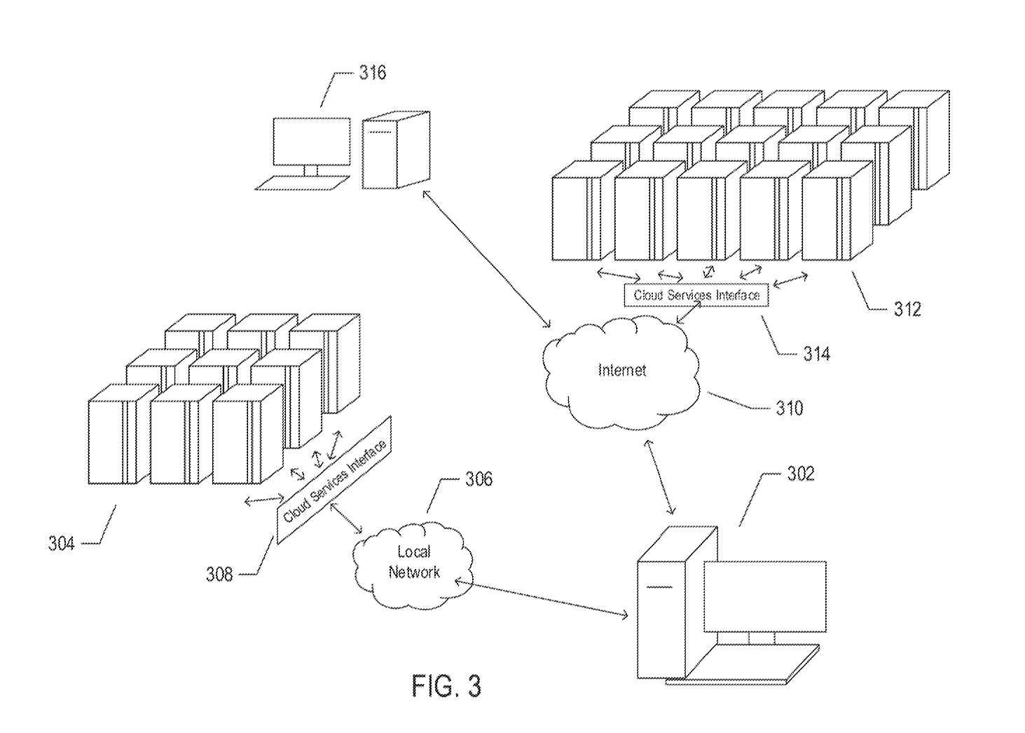

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing fatcilities used by a single organization.

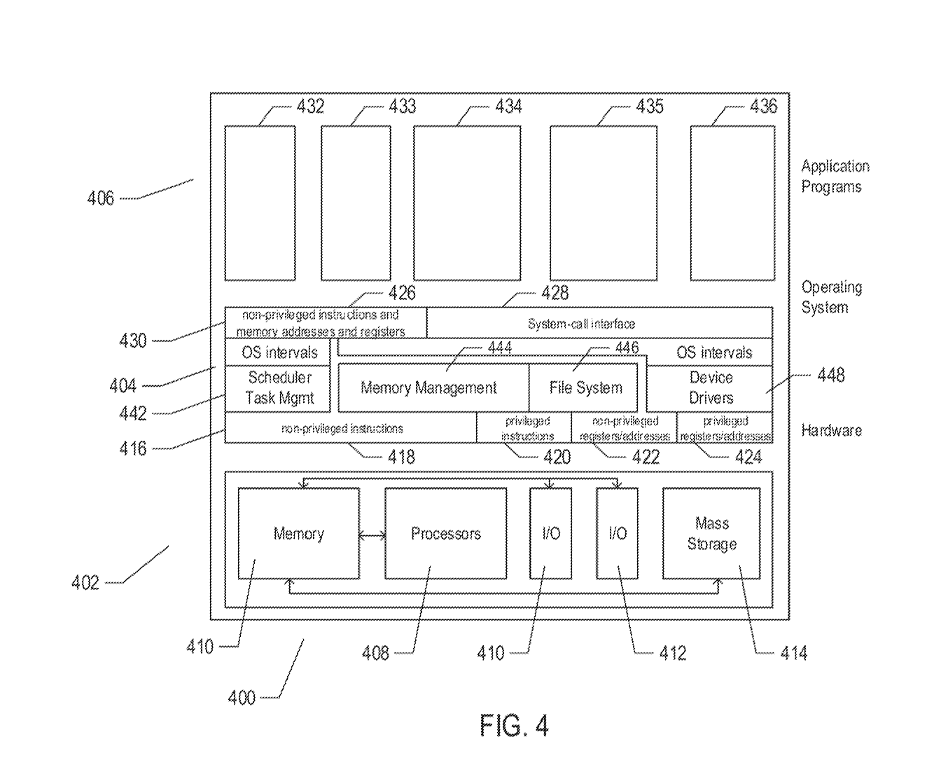

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer 402; (2) an operating-system layer 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware layer 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

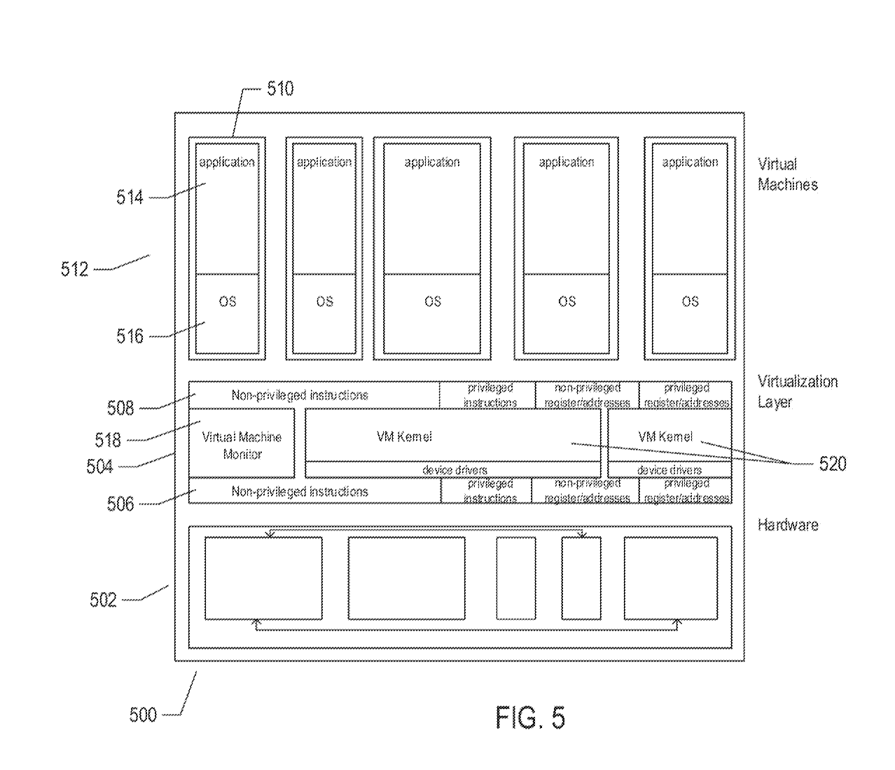

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in Figure SA features a virtualization layer 504 that interfaces through a virtualization-layer/hardware-layer interface 506, equivalent to interface 416 in FIG. 4, to the hardware. The virtualization layer 504 provides a hardware-like interface 508 to a number of VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization-layer interface 508 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization-layer interface 508 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization-layer interface 508, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

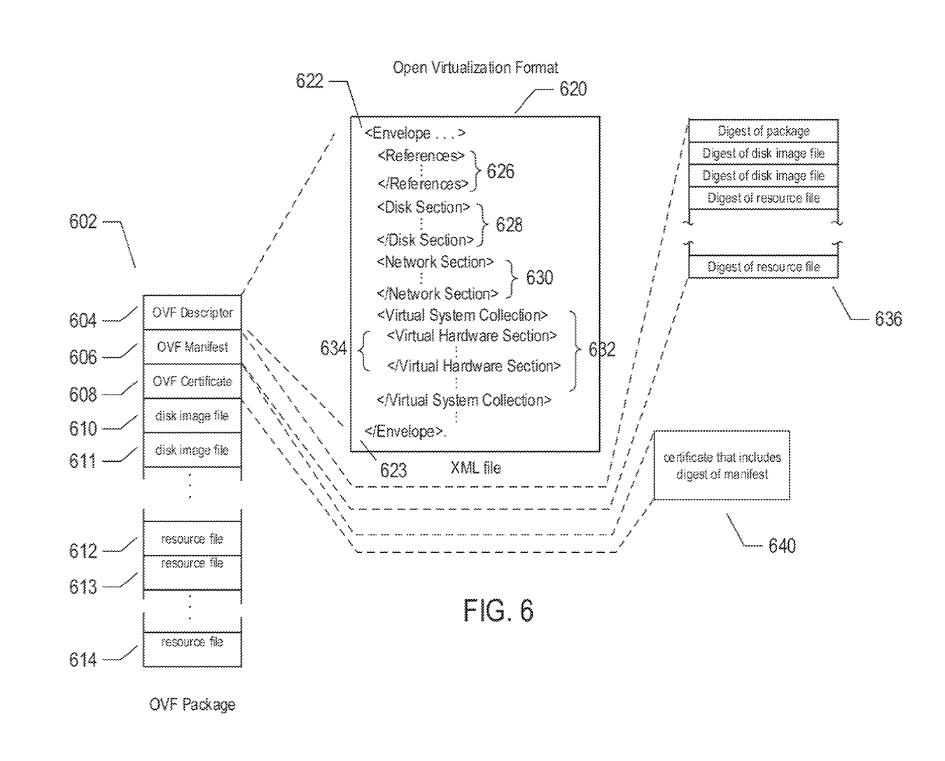

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or entirely eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

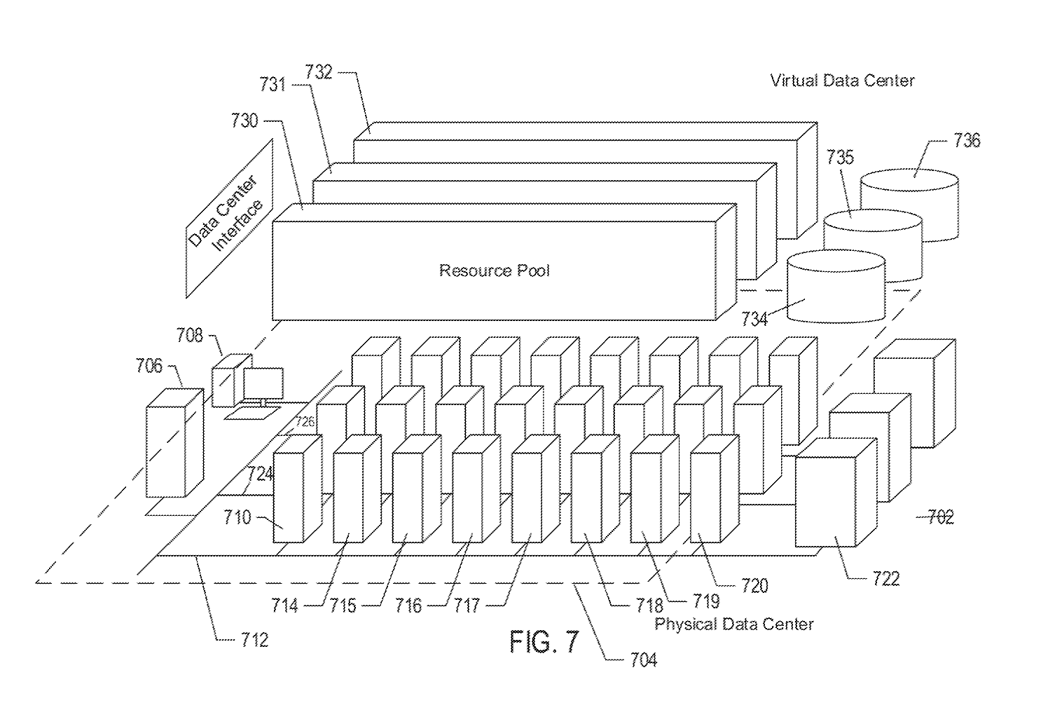

FIG. 7 shows virtual data centers provided as an abstraction of underlying physical-data-center hardware components. In FIG. 7, a physical data center 702 is shown below a virtual-interface plane 704. The physical data center consists of a virtual-data-center management server 706 and any of various different computers, such as PCs 708, on which a virtual-data-center management interface may be displayed to system administrators and other users. The physical data center additionally includes generally large numbers of server computers, such as server computer 710, which are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of physical servers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server 706 includes functionality to migrate running VMs from one physical server to another in order to optimally or near optimally manage device allocation, provide fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual physical servers and migrating VMs among physical servers to achieve load balancing, fault tolerance, and high availability.

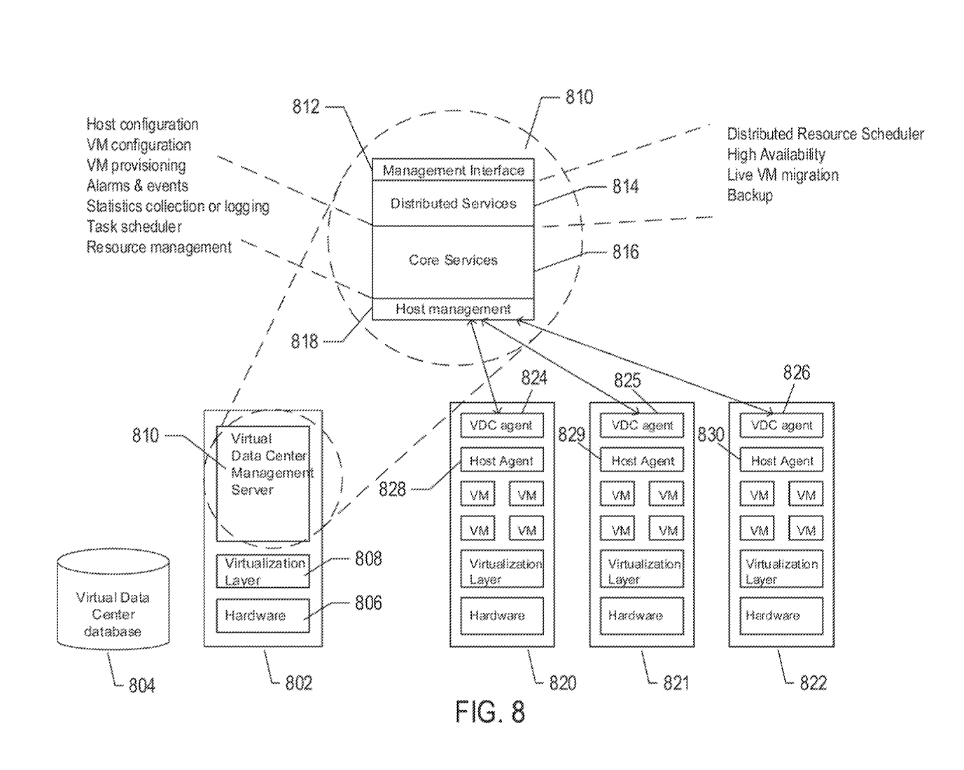

FIG. 8 shows virtual-machine components of a virtual-data-center management server and physical servers of a physical data center above which a virtual-data-center interface is provided by the virtual-data-center management server. The virtual-data-center management server 802 and a virtual-data-center database 804 comprise the physical components of the management component of the virtual data center. The virtual-data-center management server 802 includes a hardware layer 806 and virtualization layer 808, and runs a virtual-data-center management-server VM 810 above the virtualization layer. Although shown as a single server in FIG. 8, the virtual-data-center management server (“VDC management server”) may include two or more physical server computers that support multiple VDC-management-server virtual appliances. The virtual-data-center management-server VM 810 includes a management-interface component 812, distributed services 814, core services 816, and a host-management interface 818. The management interface 818 is accessed from any of various computers, such as the PC 708 shown in FIG. 7. The management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the physical servers of the physical data center that is abstracted to a virtual data center by the VDC management server.

The distributed services 814 include a distributed-device scheduler that assigns VMs to execute within particular physical servers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server, and restarts the VM on the different physical server from a virtual-machine state recorded when execution of the VM was halted. The distributed services 814 also include a distributed backup service that provides centralized virtual-machine backup and restore.

The core services 816 provided by the VDC management server 810 include host configuration, virtual-machine configuration, virtual-machine provisioning, generation of virtual-data-center alarms and events, ongoing event logging and statistics collection, a task scheduler, and a device-management module. Each physical server 820-822 also includes a host-agent VM 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce device allocations made by the VDC management server 810, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

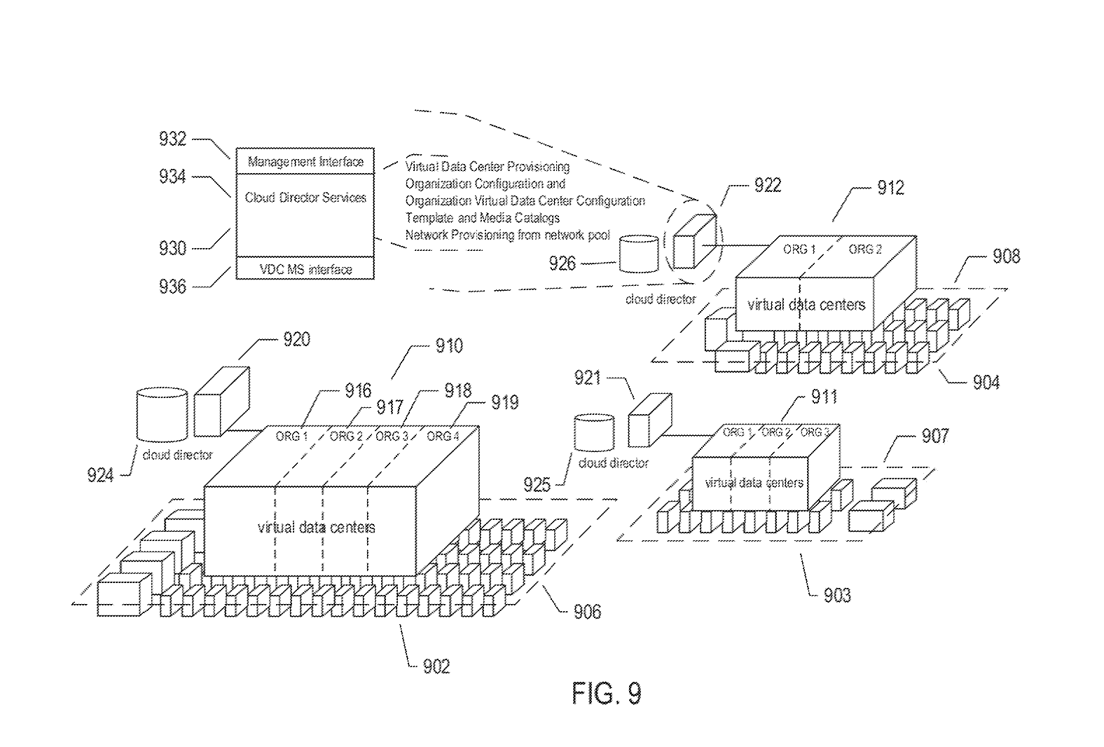

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

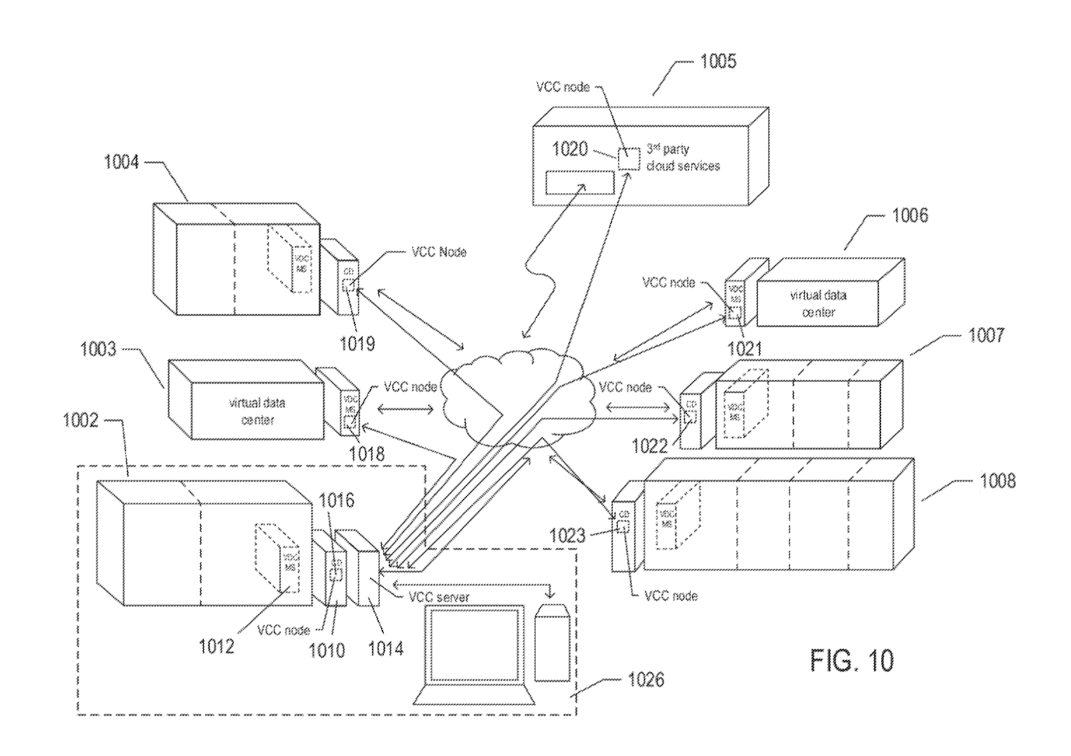

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

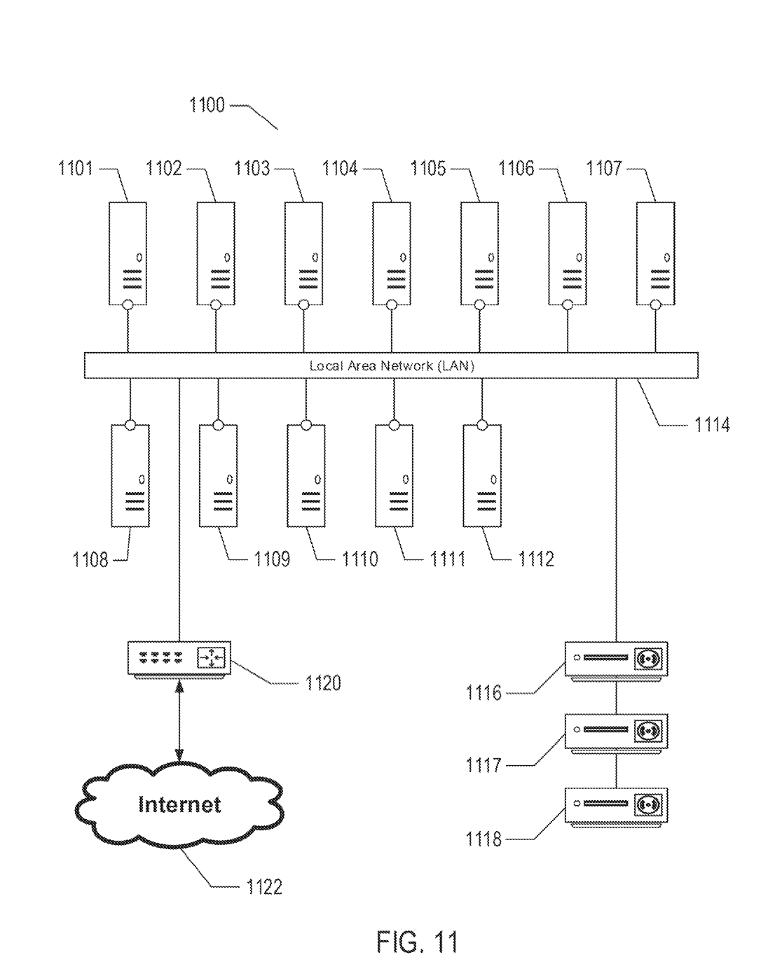

Many modern data centers are made up of a mixture of computational resources that includes general-purpose computer systems, virtual-machine execution environments, network-connected storage systems, and networks. A particular example of a modern data center is illustrated in FIG. 11. The data center 1100 includes a number of computer systems 1101-1112. Each computer system can act as a host for application programs, VMs, or a combination of application programs and VMs. In some implementations, a particular computer system is dedicated to hosting a single application program. The computer systems 1101-1112 are interconnected via a local area network (“LAN”) 1114. The LAN 1114 can be based on one or more network technologies including Ethernet, fibre optic, wireless, or infrared networking technologies. The topology of the LAN can include OSI level-2 packet-level segmentation and/or OSI level-3 packet routing to optimize the flow of network traffic and to provide isolation between network segments. The LAN 1114 connects the computer systems 1101-1112 to various data center resources that include remote disk storage devices 1116-1118 and routers 1120. In the illustrated example data center, the router 1120 is connected to the Internet 1122. In some data center implementations, the LAN is connected to database servers, printers, scanners, or optical storage systems.

Virtual networks are able to deploy and configure a number of software-based network appliances to create a virtual network structure on top of a different underlying physical network structure. For example, multiple VMs that are hosted on a physical server can be connected to a virtual network segment created on the same physical server. The virtual network segment can be connected to a physical network by way of a virtual router or virtual firewall that interfaces to a physical network adapter within the physical server. The entire virtual network structure exists within the single physical host server. Generally, the VMs and the software applications running on the VMs are able use the network services provided by the virtual network in the same way as they would use network services provided by a similarly-structured hardware-based network. However, since the appliances that make up a virtual network are implemented and configured primarily in software, the appliances can be created, modified, and managed far more easily than their hardware-based equivalents. Virtual networking platforms are not limited to virtual networks running on a single server. Virtual networks can be implemented on a group of servers connected with a LAN or, in some implementations, on a number of servers connected across a wide area network such as the Internet. A virtual network can be used to create secure virtual network segments that isolate particular network services and resources from the larger physical network.

### A Discussion of Virtual Networks

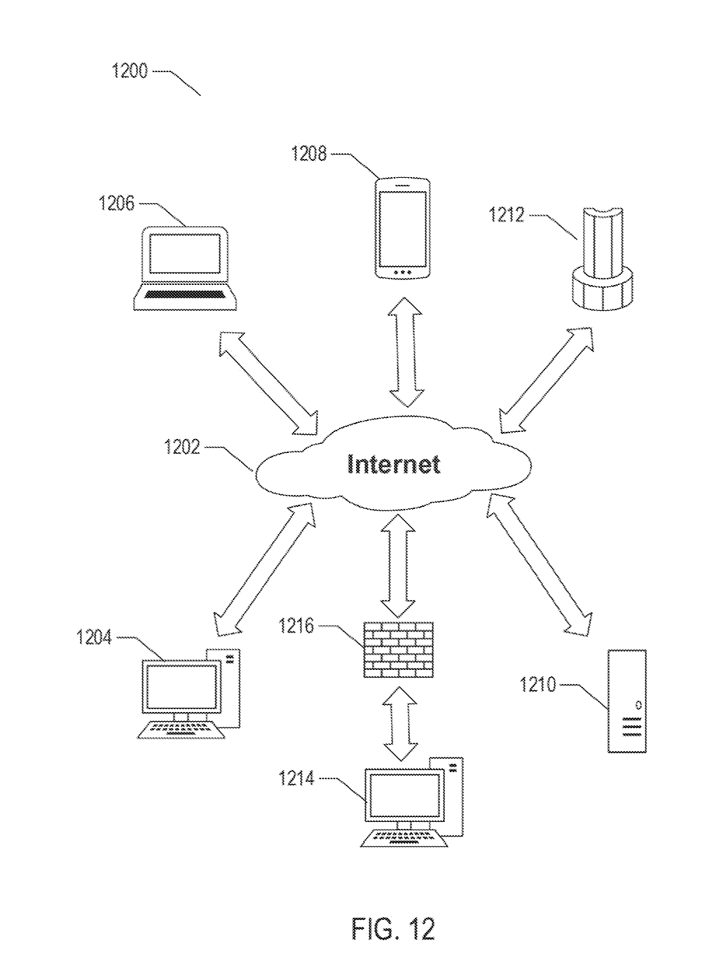

FIG. 12 illustrates a computer network with a variety of interconnected network client devices. A large physical network 1200 connects a variety of network client devices to each other over the Internet 1202. The connected network client devices include a personal computer 1204, a laptop computer 1206, and a mobile device 1208. A server 1210 and a mainframe 1212 provide web-page-serving services, cloud computing services, and database services. Additional network client devices are connected to the network indirectly such as personal computer 1214 which is connected to the Internet 1202 through a firewall 1216.

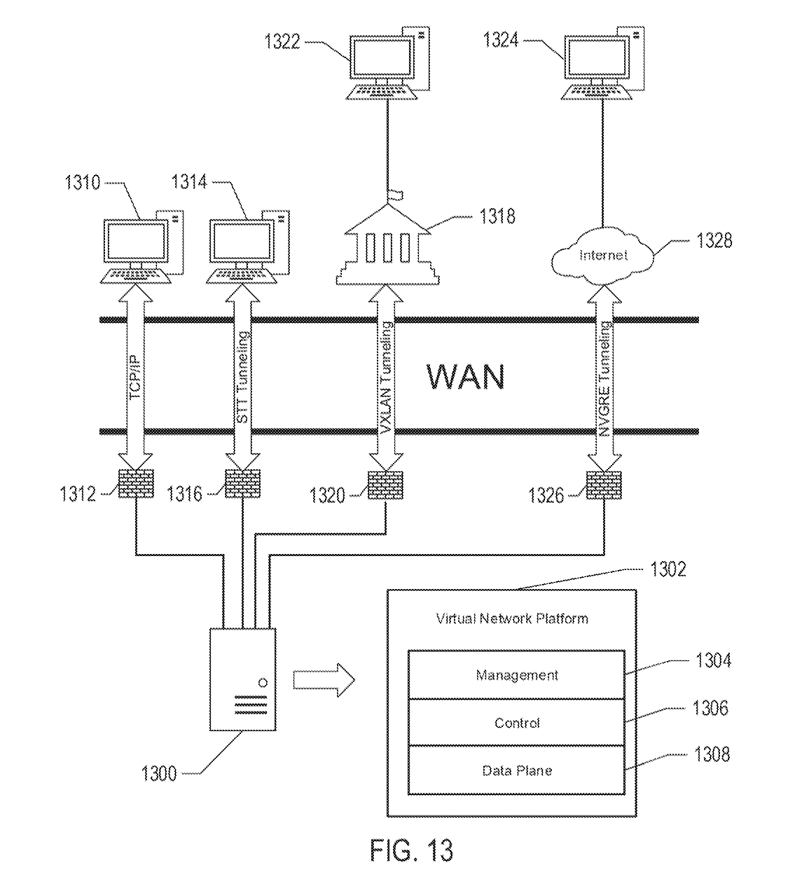

A small secure network can be deployed over a larger less-secure network by deploying a virtual network over a wide area network (“WAN”) and by connecting authorized network client devices to the virtual network by tunnelling over the WAN. FIG. 13 illustrates a variety of networked client devices and client networks that are connected to a virtual network provider. In a virtual network, certain network appliances and/or network services are deployed and configured through software on a virtual network platform. In the implementation illustrated in FIG. 13, a virtual network server 1300 is running a virtual network platform 1302. The virtual network platform 1302 includes a management plane 1304, a control plane 1306, and a data plane 1308. The management plane 1304 provides a deployment and configuration interface that configures virtual switches and connects network client devices, such as virtual machines, personal computers, and mobile devices to the virtual switches. The control plane 1306 manages the switching and control modules in the hypervisors. In certain implementations, the controller plane 1306 is distributed across multiple controller nodes that manage specific virtual switches. The data plane 1308 implements the virtual switches and provides access-level switching in the hypervisor. The data plane creates a flexible OSI level-2 virtual network structure overlaid over the existing physical network structure.

Physical or virtual network client devices can be connected to the virtual network by way of network endpoints. In certain implementations, network endpoints are implemented with a network tunnelling protocol such as Stateless Transport Tunnelling (“STT”). Virtual Extensible LAN (“VXLAN”), or Network Virtualization using Generic Routing Encapsulation (“NVGRE”). These or other tunnelling protocols encapsulate traffic from the virtual network over the physical network. In other implementations, network endpoints are formed using network bridging or network address translation (“NAT”) firewalls. Virtual network clients or VMs can be connected to virtual networks with a virtual network adapter. Virtual network adapters are OSI level-2 devices that present the software interface of a physical network adapter to the VM, while interfacing with the level-2 features of the virtual network.

The network client devices illustrated in FIG. 13 show several possible methods of connecting physical network client devices to a virtual network. A first personal computer 1310 is connected to a TCP/IP bridged endpoint 1312. A second personal computer 1314 is connected to an STT endpoint 1316 using STT tunnelling. Some computer systems may be indirectly connected to a virtual network. For example, corporate network 1318 is connected to the virtual network via a VXLAN endpoint 1320 using VXLAN tunnelling router. Corporate computer 1322 is connected to the corporate network, and can access the virtual network through the corporate router. A third personal computer 1324 connects to the virtual network through an NVGRE endpoint 1326 across the Internet 1328.

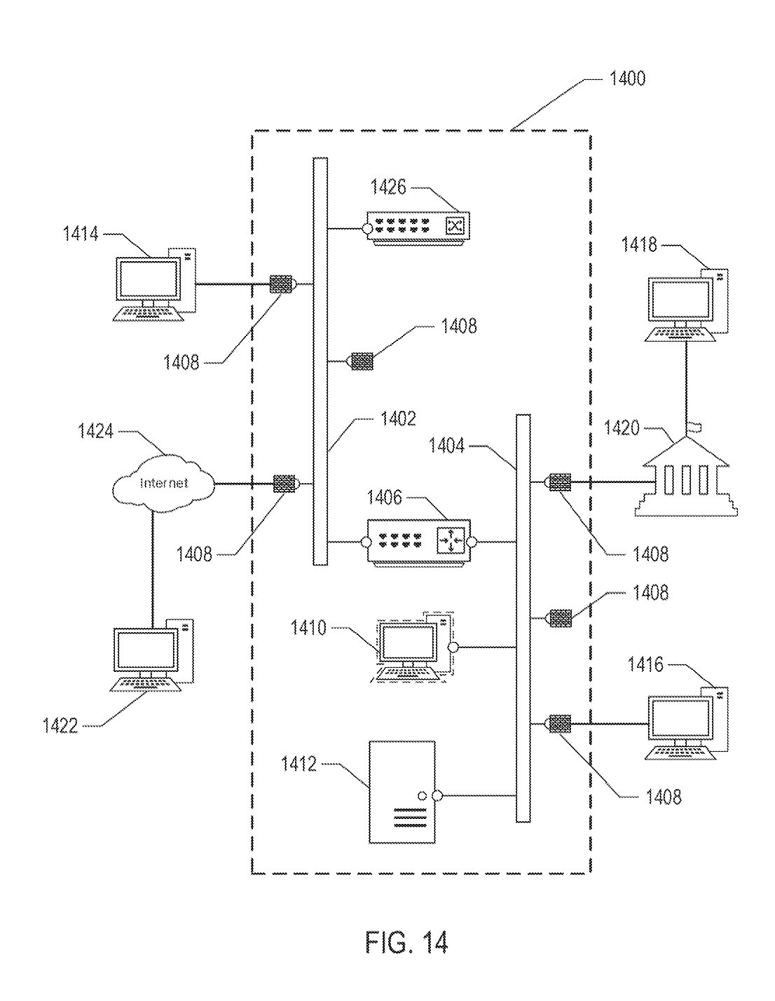

Once the network client devices are connected to the virtual network server 1300, the virtual network platform 1302 can be configured to provide a virtual network structure desired by the network administrator. FIG. 14 illustrates one possible virtual network structure that can be configured by the virtual network provider. The virtual network 1400 has a first virtual network segment 1402 and a second virtual network segment 1404. The first and second virtual network segments are connected with a virtual router 1406. Network endpoints 1408 are provided to facilitate connectivity to various network client devices. Certain network client devices are virtual such as VM 1410 or virtual server 1412. Physical network client devices include those illustrated in FIG. 6. A first personal computer 1414 is connected to the first virtual network segment 1402. A second personal computer 1416 is connected to the second virtual network segment 1404. Corporate computer 1418 is connected to a corporate network 1420, which is connected to the second virtual network segment 1404. A third personal computer 1422 is connected to the first virtual network segment 1402 over the Internet 1424. The virtual network 1400 provides a load-balancing appliance 1426. The load-balancing appliance 1426 provides load-balancing services, and is implemented in the virtual network platform as part of the virtual network.

The virtual network 1400 can be implemented on the hardware and software platform illustrated in FIG. 13. From the point of view of the network client devices, the network structure implemented by the virtual network 1400 operates similarly to a corresponding physical network. However, because the virtual network's structure and configuration is controlled by the configuration of the virtual networking platform, the virtual network can be deployed and modified by a network administrator without the need to reroute cables or modify the underlying physical network hardware. For example, the network administrator could relocate the connection of the first personal computer 1414 from the first virtual network segment 1402 to the second virtual network segment 1404 by reconfiguring the virtual network platform and without having to reroute a physical network cable.

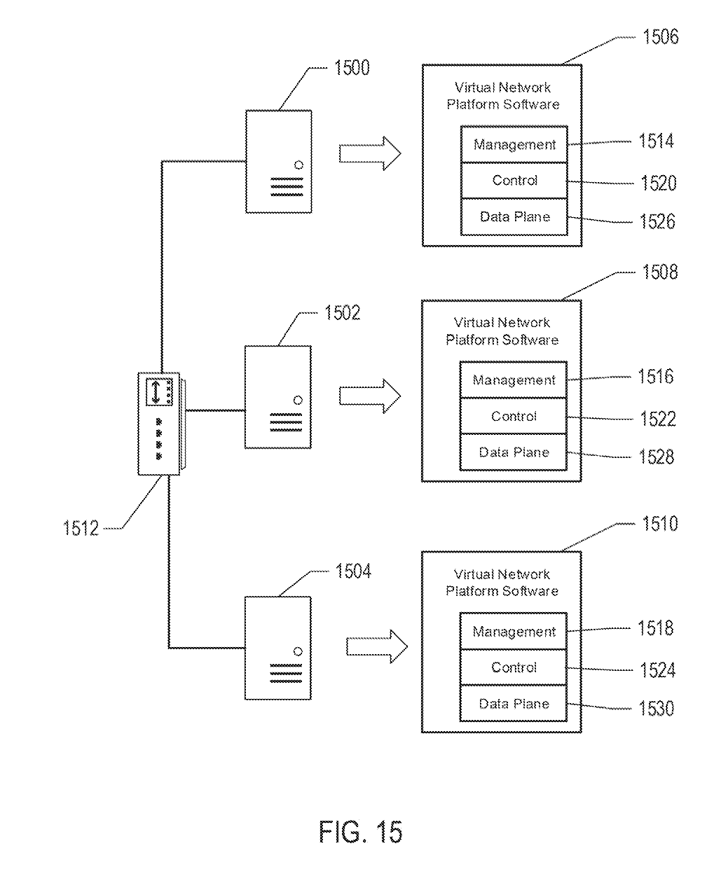

In certain implementations, a virtual network implementation is coordinated across multiple interconnected physical servers that are each running virtual network platform software. In one example, FIG. 15 illustrates physical networking hardware and physical servers configured with virtual network platform software that provides virtual networking services. Three physical servers 1500, 1502, and 1504 are each configured with an instance of virtual network platform software 1506, 1508, and 1510 respectively. Each instance of the virtual network platform software is interconnected over a LAN by way of a physical network switch 1512. The servers create a virtual network platform having coordinated management planes 1514, 1516, and 1518, control planes 1520, 1522, and 1524, and data planes 1526, 1528, and 1530. The resulting virtual network platform can be scaled up by adding additional servers and/or by increasing the data transmission capacity of the underlying physical network appliances.

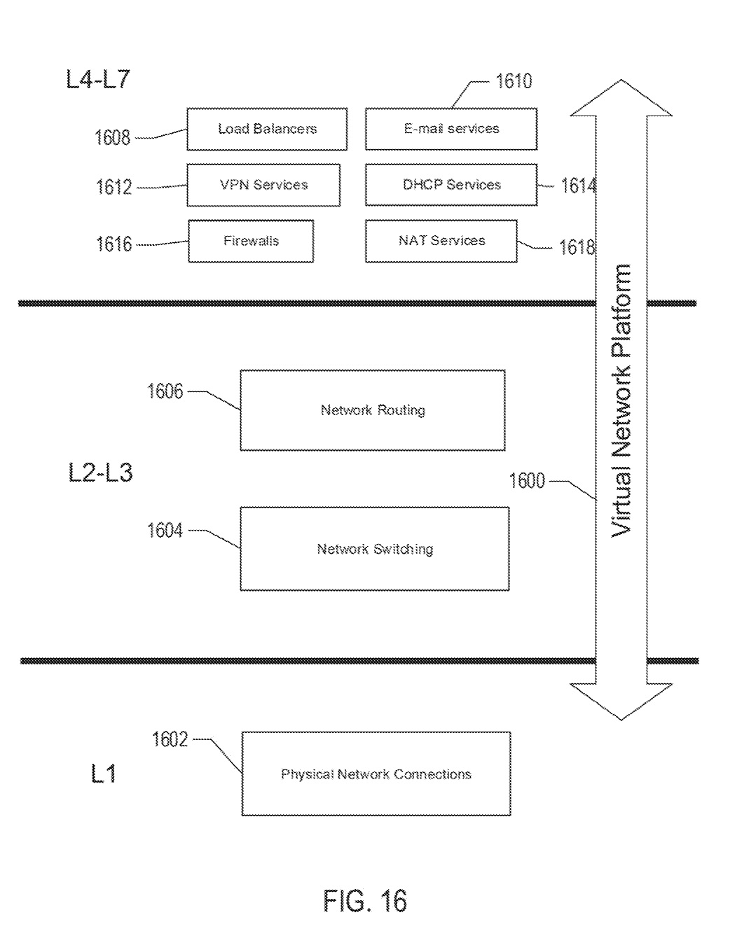

FIG. 16 illustrates various network services and network functions that can be provided by a virtual network platform. The services provided by the virtual network platform 1600 are illustrated in the context of the OSI model. Level-1 of the OSI model is the physical layer. The physical layer includes physical network connections 1602. In many virtual networks, physical network connections 1602 are not virtualized because there is no need to emulate the flow of electrons, light pulses, or electromagnetic waves to achieve adequate logical network functionality. Level-2 and level-3 of the OSI model include network switching services 1604 and network routing services 1606. In some implementations, virtual network platforms provide level-2 and level-3 network segmentation through the deployment and configuration of virtual switching appliances and virtual router appliances. Levels 4 to 7 of the OSI model include higher level network services such as load balancers 1608, e-mail servers 1610, virtual private networks (“VPNs”) 1612, dynamic host configuration protocol (“DHCP”) services 1614, firewall servers 1616, and NAT firewalls 1618. The functions of a virtual network can be classified as common functions, and service-specific functions. Most Level-2 and level-3 services are common services that support the operation of the network as a whole, whereas many higher-level services such as e-mail servers and firewalls are service-specific functions.

In some data centers, both the network and the network's client devices are virtualized resulting in a highly flexible, reconfigurable, manageable data center. Such data centers can be deployed and scaled using generic computing and network resources because, in general, the structure of the data center need not resemble the structure of the virtual networks or VMs running within the data center. In such an environment, determining how to allocate data center costs to data center VMs is difficult.

### Methods and Systems that Measure and Allocate Virtual Networking Costs

Methods and systems described herein measure and allocate virtual network cost to physical data center tenants. Virtual network cost is categorized as operational expenditure and capital expenditure. Operational expenditure may be broken down into virtual appliance expenditures to provide virtual network and virtual network services denoted by Cᵥₙ, software licence fee denoted by Cₗ, and labor denoted by C_{lab}. Capital expenditure denoted by Cₑ is the cost of physical servers used to deploy the appliances. The cost of virtual network appliances Cᵥₙ is equal to the infrastructure cost of VMs on which the VMs are deployed. The license fee Cₗ is the amortized perpetual licence cost over the period. The labor cost C_{lab} is determined based on actual hours or salaries of network administrators over the period. In order to compute the capital expenditure Cₑ of a physical data center, an inventory of devices connected to various networks of the data center is first determined using network monitoring tools. A network monitoring tool may model LAN and wireless networks, physical and virtual networks and is able to identify all physical devices (e.g., server computers, switches, and routers) connected to each network of the physical data center and associated physical and logical ports. A physical device list may be obtained by querying host configurations across clusters in the physical data center. An inventory of the devices connected to networks of the physical data center is formed by combining automatically discovered devices, pNICs, and manually entered cable infrastructure details. Once a list of devices connected to networks of the physical data center has been determined, an amortized cost of each device in the list is computed and summed to obtain the capital expenditure Cₑ of the physical data center. A total cost of a virtual network over the period is given by

Cₜₒₜ=Cᵥₙ+Cₗ+C_{lab}+Cₑ (1)

Virtual network cost allocation to customers is carried out in accordance with the following rules:
Common infrastructure cost and license cost are allocated to those VMs that are using the virtual network in proportion to each VM bandwidth utilization.
Costs of particular network services are allocated to those VMs that are using the particular network services in proportion to their utilization of the particular network service.
Unused physical network bandwidth contributes to unallocated virtual network cost.

Allocating the cost of a virtual network to a data center tenant running K VMs on the virtual network is accomplished by first computing a total common cost over the period as follows:

total common cost(C_{c})=Cₗ+Cᵢ (2)

where
Cₗ is license cost; and
Cᵢ is the common network infrastructure cost, which includes cost of kernel modules and tunnelling in VMM approximated as a certain percentage of infrastructure cost.
   The common network infrastructure cost does not include cost of network services. An effective bandwidth for the virtual network is determined as follows:

effctive network bandwidth(Bₑ)=max(Bₗ,Bᵢ) (3)

where
Bₗ is the bandwidth of a LAN used by a tenant's VMs; and
Bᵢ is the Internet bandwidth provided by an Internet service provider.
   A LAN bandwidth may be determined by the bandwidth of the physical communication channels comprising the LAN. For example, for a LAN with N Gb Ethernet cables the maximum network bandwidth between any two devices interconnected on the LAN is N Gbps. The bandwidth utilization of each VM the tenant runs on the virtual network over the period is determined by a VM monitoring tool that tracks the number and size of network data packets sent and received by each VM over the time period. The bandwidth utilization by the k^{th} VM of the K VMs is denoted by VMUtilizationₖ. The bandwidth utilization VMUtilizationₖ may be the rate of received and transmitted bytes over the virtual network by the k^{th} VM.

Network services are partitioned into two sets. A network service may be an application running at the network application layer that provides data storage, manipulation, presentation, communication or other capabilities. A first set is composed of external or Internet-based network services and a second set is composed of network services that remain with the LAN of the data center. The two sets of network services are denoted by

SGᵢₙₜₑᵣₙₑₜ={S₁,S₂, . . . ,Sₘ} (4a)

SG_{LAN}={Sₘ₊₁,Sₘ₊₂, . . . ,S_{M}} (4b)

where
M represents the total number of virtual network services; and
m is a network service index.
   The set SGᵢₙₜₑᵣₙₑₜ is the set of network services provided by the virtual network over the Internet, and the set SG_{LAN} is the set of network services provided by the virtual network over the LAN. Services S₁ through Sₘ are network services provided over the internet and services Sₘ₊₁ through S_{M} are network services provided over the LAN. Examples of a network services include access to the Internet, domain name systems, network management protocols, time services, and network address translation (“NAT”). Each network service has a network service cost denoted by Cₘ and a network service capacity Pₘ. The network service cost may be computed as the sum cost of virtual appliances if the virtual appliances are VMs, otherwise the network service cost may be the sum cost of physical machines. On the other hand, the network service capacity differs depending on the network service. Service capacity is measured in units based on the quality of the network service provided. For example, the service capacity of a firewall service can be measured in terms of Gigabits per second (“Gbps”) or in terms of maximum connections. In another example, the service capacity of a DHCP service is measured in terms of the number of network addresses provided. In still another example, service capacity of NAT is typically measured as the number of concurrent NAT sessions.

VM utilization of network services may be stored in service to VM utilization table denoted by T. An example of a service to VM utilization table for two network services used by three VMs is represented as follows:

| Network service | Virtual machine | Utilization (%) |
|---|---|---|
| S₁ | VM₁ | 20 |
| S₁ | VM₂ | 35 |
| S₁ | VM₃ | 10 |
| S₂ | VM₁ | 40 |

A function u(T, Sₘ, VMₖ) represents a look-up function applied to a service to VM utilization table T to look a service Sₘ used by a k^{th} VM. For example, virtual machine VM₂ utilization of network service Sₗ is u(T, S₁, VM₂)=35.

An effective cost of a k^{th} VM use of a virtual network is computed according to

$$eff cost for {VM}_{k} = ( \frac{{C}_{C}}{ {B}_{e}} \cdot {VMUtilization}_{ k} ) + {\sum }_{m = 1}^{M} ( \frac{{C}_{m}}{{P}_{m}} \cdot u ( T , {S}_{m} , {VM}_{k} ) ) \qquad ( 5 )$$

where

$$( \frac{{C}_{C}}{ {B}_{e}} \cdot {VMUtilization}_{ k} )$$

is common cost for VMₖ;

$$( \frac{{C}_{m}}{{P}_{m}} \cdot u ( T , {S}_{m} , {VM}_{k} ) )$$

is cost of network service Sₘ used by VMₖ; and

$${\sum }_{m = 1}^{M} ( \frac{{C}_{m}}{{P}_{m}} \cdot u ( T , {S}_{m} , {VM}_{k} ) )$$

is total cost of M network services used by VMₖ.
The total allocated cost to all K VMs is given by

$$Total Allocated Cost = {\sum }_{k = 1}^{K} eff cost for {VM}_{k} \qquad ( 6 )$$

Any unused bandwidth adds to unallocated virtual network cost. Total unallocated virtual network cost is computed according to

$$Total Unallocated Cost = ( {C}_{c} + {\sum }_{m = 1}^{M} {C}_{m} ) - Total allocated Cost \qquad ( 7 )$$

where (C_{c}+Σₘ₌₁^{M}Cₘ) represents total common cost and total network services costs.

In certain implementations, the ratio of unallocated costs to total costs may be used to adjust the resources allocated to operating the virtual network. The ratio of unallocated costs to total costs is compared to a maximum threshold and a minimum threshold. When the ratio is greater than the maximum threshold, resources allocated to the operation of the virtual network are increased. Increasing the resources may be accomplished by adding physical or virtual appliances to the network or by deploying additional servers to the operation of the virtual network. When the ratio is less than a minimum threshold, resources allocated to the virtual network are decreased. Resources may be decreased by reducing the number of servers that support the operation of the virtual network or by decommissioning network appliances from the virtual network. The adjustments to virtual network resources result in a more efficient allocation of resources to the virtual network.

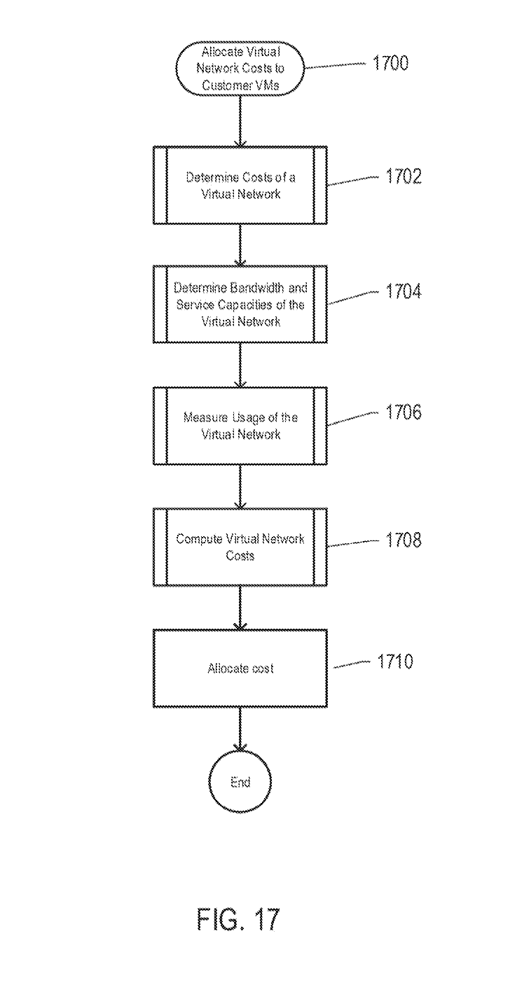

FIG. 17 illustrates a flow diagram that allocates costs of a virtual network based on VM utilization of the virtual network. The process of allocating costs begins at block 1700. At block 1702, a routine “Determine Costs of a Virtual Network” is called to compute costs of a Virtual Network. In one implementation, the costs include both capital and operational expenses divided into a group of total common costs and into groups of service-specific costs. At block 1704, a routine “Determine Bandwidth and Service Capacities of the Virtual Network” is called to determine the effective bandwidth of the virtual network and the capacities of the network services that are provided by the virtual network. At block 1706, a routine “Measure Usage of the Virtual Network” is called to measure the virtual network usage by the VMs. In one implementation, the network usage of each VM is divided into an amount of common resource usage and an amount used by each network service. At block 1708, a routine “Compute Virtual Network Cost” is called to allocate a portion of the virtual network costs to each VM based on the measured usage of each VM and the capacity and bandwidth of the virtual network. In block 1710, cost are allocated according to the virtual network cost calculated in block 1708.

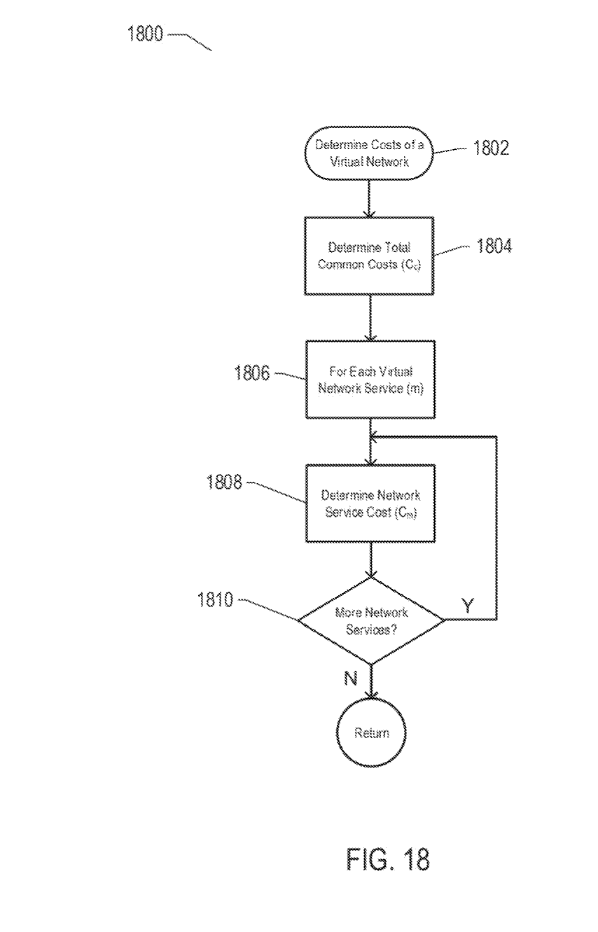

FIG. 18 illustrates a flow diagram of the routine “Determine Costs of a Virtual Network” called in block 1702 of FIG. 17. The flow diagram 1800 begins at block 1802. At block 1804, total common cost C_{c} is computed as described above with reference to Equation (2). A for-loop begins at block 1806 where a loop with a loop index n iterates over the virtual network services provided by the virtual network platform that are not in total common costs. For each iterated virtual network service, a network service cost Cₘ is determined at block 1808. The network service cost includes the cost of both utilized and unutilized service capacity. Decision block 1810 advances the loop to the next virtual network service until each virtual network service's cost has been determined.

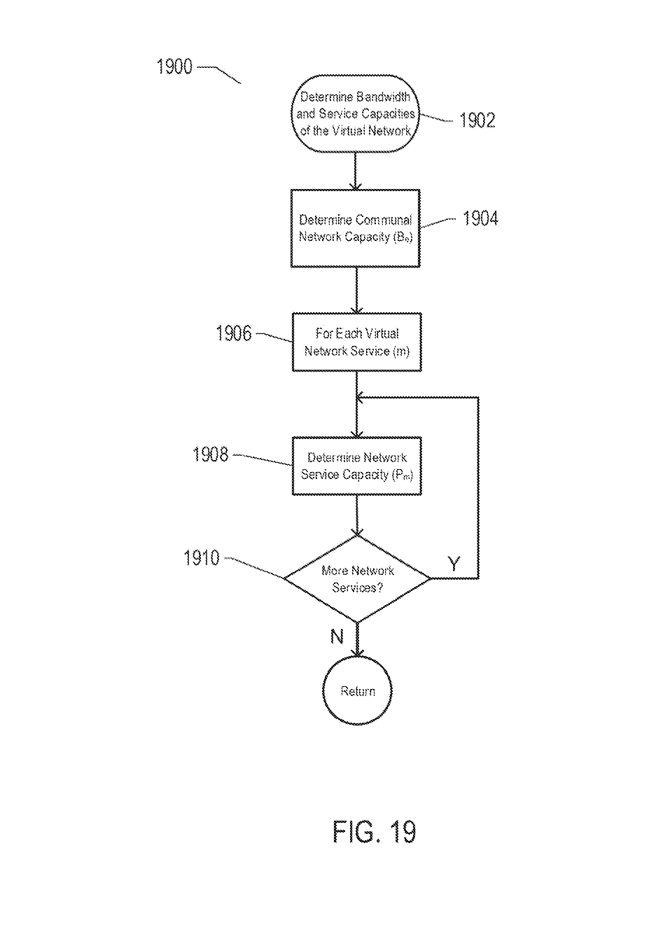

FIG. 19 illustrates a flow diagram of the routine “Determine Bandwidth and Service Capacities of the Virtual Network” that is called in block 1704 of FIG. 17. The flow diagram 1900 begins at block 1902. At block 1904 the effective bandwidth Bₑ described above with reference to Equation (3) is determined. In one implementation, the effective bandwidth is determined as the maximum bandwidth of all physical network segments that supports the virtual network. In yet another implementation, the effective bandwidth is determined by adding the bandwidth of each L3-isolated network segment that supports the virtual network. Once the effective bandwidth has been determined, execution proceeds to block 1906 where a for-loop iterates over virtual network services provided by the virtual network. For each iterated virtual network service, a network service capacity Pₘ for each network service is determined at block 1908. Decision block 1910 advances the loop to the next virtual network service until each iterated network service capacity has been determined.

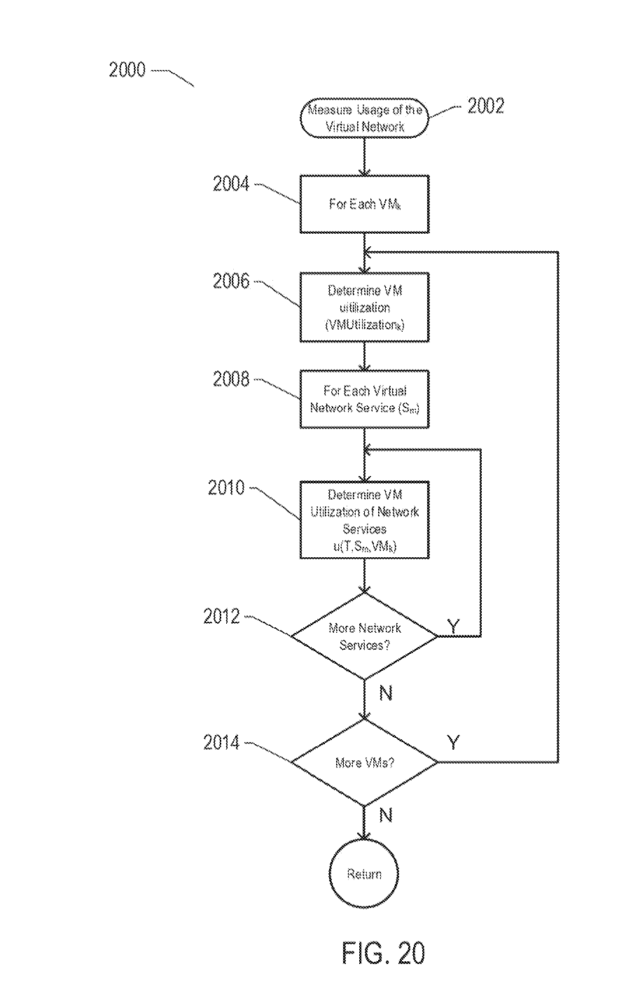

FIG. 20 illustrates a flow diagram of the routine “Measure Usage of the Virtual Network” called in block 1706 of FIG. 17. The flow diagram 2000 begins at start block 2002. At block 2004, an outer for-loop with a loop index k iterates over a tenants K VMs. At block 2006, the VM's bandwidth utilization VMUtilizationₖ is measured. At block 2008, an inner for-loop iterates over the network services. At block 2010, VM utilization of network services are determined. The VM utilization of network services may be determined from a look-up table. In other implementations, the usage of each network service by each VM may be computed as a percentage of each network service capacity. Measuring service capacity and utilization by VMs varies from network service to network service. For example, for DHCP the total number of requests can be served and the number of requests made by a VM can be measured. Network service utilization by VMs is maintained in a table and may be looked up for each VM. Each network service's capacity depends upon the capacity of the underlying network that service is connected to. For example, if network service S₁ is connected over the Internet and the Internet has a bandwidth of 4 Gbps and VM₁ uses 1 Gbps of S₁'s capacity, then the VM₁ utilization of S₁ is 25%. On the other hand, if network service S₂ is connected over a LAN and the LAN has a bandwidth of 40 Gbps and VM₂ uses 1 Gbps of S₂'s capacity, then the VM₂ utilization of S₂ is 2.5%. At block 2012, the inner loop that iterates over the network services is closed. At block 2014, the outer loop that iterates over the VMs is closed.

Allocation of virtual network costs may be accomplished by determining costs associated with providing particular network services, and then allocating the determined costs based on the usage of the particular network services. In certain implementations, costs are categorized as common costs and network-service-related costs. Common costs are allocated to VMs based on the amount each VM's network bandwidth utilization. The cost of each network service is allocated to VMs based on the proportion of each network service's capacity that each VM uses. In general, unused physical network bandwidth and unused or underused network services contribute to wastage and unallocated virtual network cost.

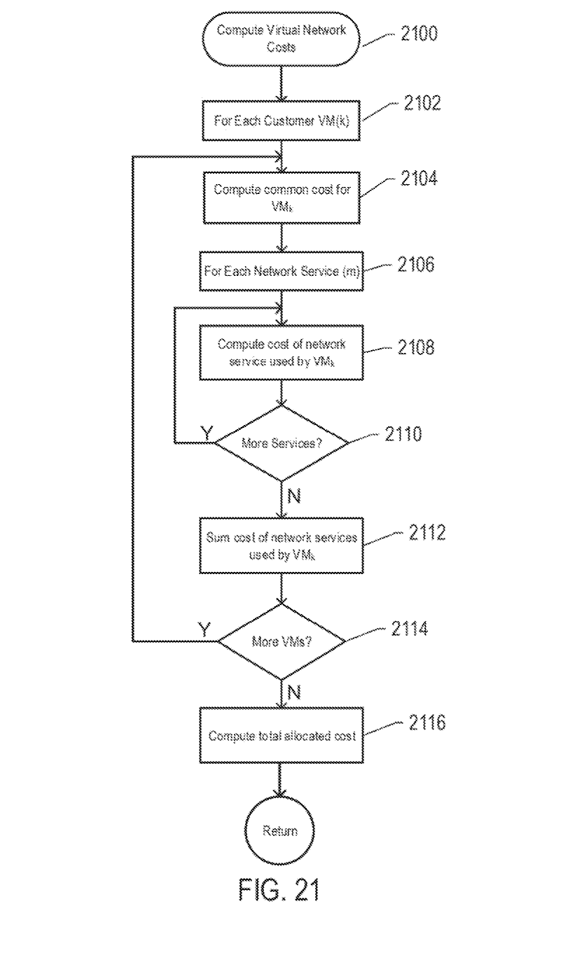

FIG. 21 illustrates a flow diagram of the routine “Allocate Virtual Network Costs” called in block 1708 of FIG. 17. The flow diagram for allocating costs begins at block 2100. At block 2102, an outer for-loop iterates over the K VMs. At block 2104, common cost for the k^{th} VM is computed as described above with reference to Equation (5). At block 2106, cost of network service Sₘ used by VMₖ is computed. At decision block 2110, control flows to block 2112 when all M network serves have been considered. At block 2112, cost of network services are summed to generated total cost of network service used by k^{th} VM. At decision block 2114, control flows to block 2116 when the outer loop that iterates over the VMs is closed. In block 2116, a total allocated cost is computed as described above with reference to Equation (6).

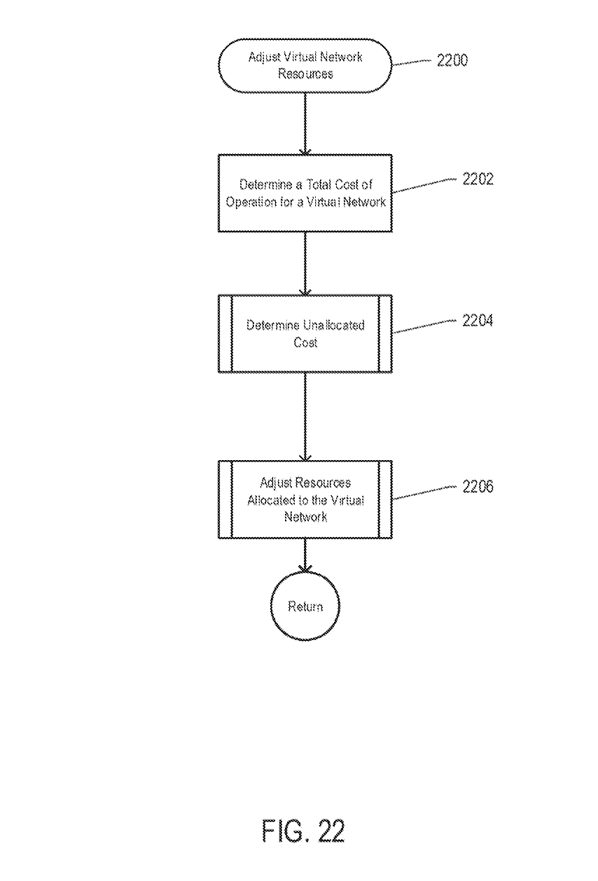

FIG. 22 illustrates a flow diagram that adjusts resources of a virtual network. The flow diagram begins at block 2200. At block 2202, the total cost of the virtual network is determined. The total cost includes allocated and unallocated costs, and may include portions of capital and operating expenses. At block 2204, a routine “Determine Unallocated Costs” is called to determine the amount of virtual network costs that are not allocated to the VMs. At block 2206, a routine “Adjust Resources Allocated to the Virtual Network” is called to adjust the resources of the virtual network based on the ratio of unallocated costs to total costs.

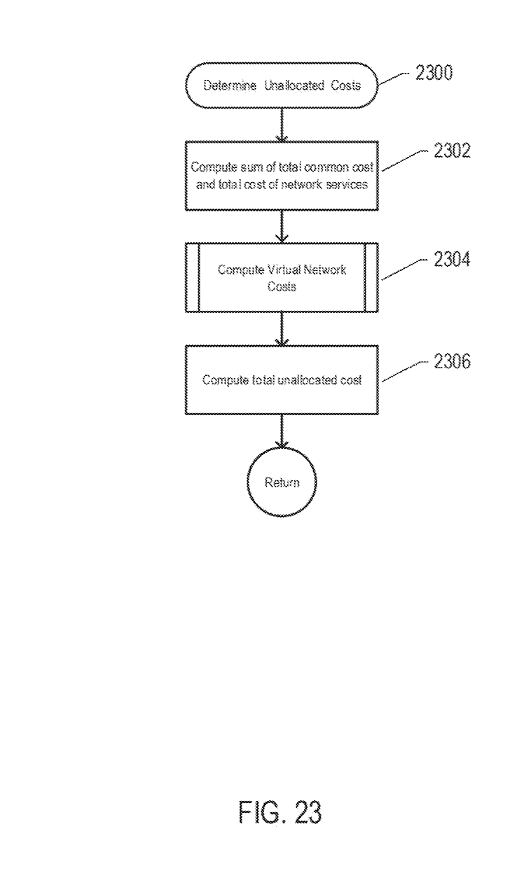

FIG. 23 illustrates a flow diagram of the routine “Determine Unallocated Costs” called in block 2204 of FIG. 22. In block 2302, compute sum of total common cost and total cost of network services. In block 2304, the routine “compute virtual network cost” described above with reference to FIG. 21 is called to compute total allocated cost. In block 2306, total unallocated cost is computed as described above with reference to Equation (7).

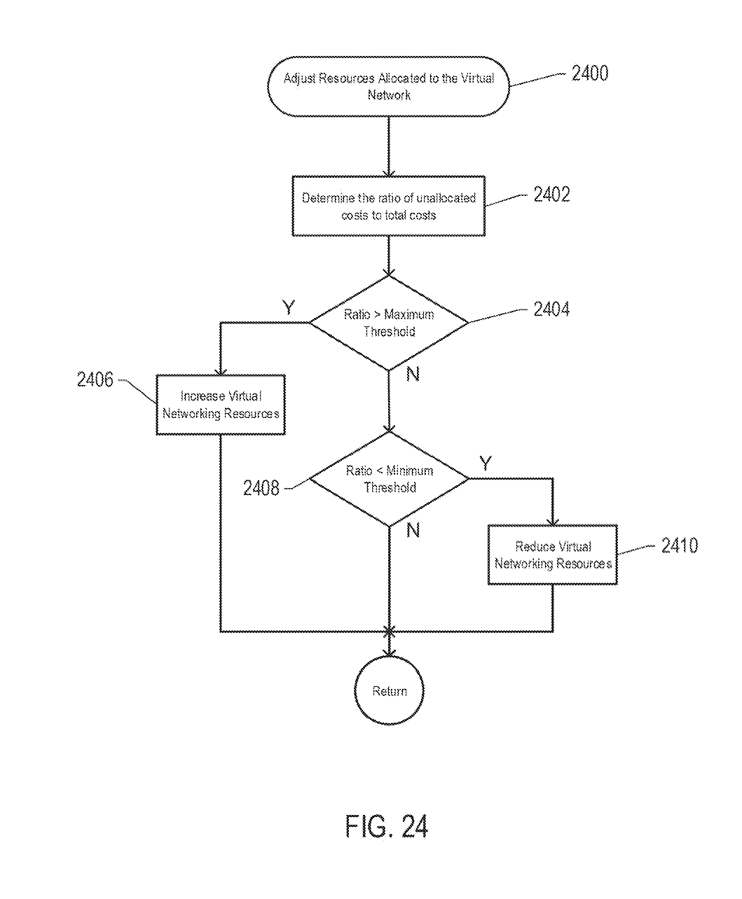

FIG. 24 illustrates a flow diagram of the routine “Adjust Resources Allocated to the Virtual Network” called in block 2206 of FIG. 22. The flow diagram for adjusting virtual network resources begins at block 2400. At block 2402, compute a ratio of total common cost and total network services costs to total allocated costs. At decision block 2404, when the ratio is greater than a maximum threshold, control flows to block 2406. At block 2406, the resources of the virtual network are increased. In certain implementations, resources are increased by deploying physical network appliances that increase the physical network bandwidth underlying the virtual network. In another implementation, resources are increased by increasing the number of servers running virtual network platform software, or by increasing the computing power of the existing servers that run the virtual network platform software. When the ratio is less than the maximum threshold, control flows to decision block 2408. At decision block 2408, when the ratio is less than a minimum threshold, control flows to block 2410. At block 2410, the resources of the virtual network are reduced. In certain implementations, resources are reduced by reducing the purchased network bandwidth of particular network segments. In another implementation, resources are reduced by decreasing the number of servers that are running virtual network platform software, or by decreasing the computing resources available to the existing virtual network servers. In some implementations, the virtual network platform, in response to a request to change the capacity of the virtual network, increases or decreases the resources used by the virtual network without human intervention. In other implementations, in response to a request, a network administrator arranges for physical resources to be deployed and configured for use by the virtual network. The amount of resources allocated to the virtual network may be adjusted to a range that allows for increased virtual network utilization without an excessive amount of unallocated costs.

### An Example of Cost Allocation

The process of determining and allocating costs associated with the deployment and operation of a virtual network is illustrated in the following example. Table 1 displays operational parameters and costs associated with a virtual network. The virtual network operates over a physical LAN segment having a bandwidth of 10 Gbps (B₁), and an Internet network segment having a bandwidth of 1 Gbps (B₁). The effective network bandwidth Bₑ is determined by taking the maximum of the Internet network segment bandwidth and the LAN segment bandwidth. In this example, the effective network bandwidth Bₑ is 10 Gbps. The common network costs include operational and capital expenses. In the example of table 1, the amortized capital exposes are represented by a $100 network hardware expense and the operational expenses are represented by a $100 network software license fee, for a total common costs (C_{c}) of $200. VM₁ uses 2 Gbps of common bandwidth and VM₂ uses 3 Gbps of common bandwidth. Applying the technique described above, VM is allocated $40 of cost (($200/10 Gbps)*2 Gbps), and VM₂ is allocated $60 of cost (($200/10 Gbps)*3 Gbps).

TABLE 1
Accumulation and Allocation of Common Network Costs

| Effective Network Bandwidth Bₑ | 10 Gbps |
|---|---|
| LAN Bandwidth B_{L} | 10 Gbps |
| Internet Bandwidth B_{I} | 1 Gbps |
| Common costs C_{c} | $200.00 |
| Network hardware | $100.00 |
| Network software | $100.00 |
| Network Utilization of each VM | |
| VM₁ | 2 Gbps |
| VM₂ | 3 Gbps |
| Allocation of common costs | |
| VM₁ | $40.00 |
| VM₂ | $60.00 |
| Unallocated | $100.00 |

Table 2 displays the allocation of costs associated with a virtual firewall service. In the example illustrated in Table 2, the firewall has a service capacity of 5 Gbps and a total cost of operation of $20 for the accounting period represented by Table 2. VM1 has used 30% or 1.5 Gbps of firewall services, and VM2 has used 20% or 1 Gbps of firewall services. The firewall costs are allocated using a previously described implementation. VM1 is allocated $6 of cost (%30 of $20), and VM2 is allocated $4 of cost (%20 of $20). $10 of cost is unallocated because VM1 and VM2 did not use %50 of the available firewall capacity.

TABLE 2
Accumulation and Allocation of Network Service Costs

| Service Type | |
|---|---|
| Firewall | |
| Network Service Capacity | |
| Firewall Capacity | 5 Gbps |
| Service Costs | |
| Firewall Cost | $20.00 |

| Firewall Service Utilization of each VM | Percentage | Usage |
|---|---|---|
| VM₁ | 30.00% | 1.5 Gbps |
| VM₂ | 20.00% | 1 Gbps |

| Allocation of Firewall Service Costs | |
|---|---|
| VM₁ | $6.00 |
| VM₂ | $4.00 |
| Unallocated | $10.00 |

Table 3 displays the allocation of costs associated with a load balancing service. In the example illustrated in Table 3, the load balancer has a service capacity of 20 Gbps and a total cost of operation of $80 for the accounting period represented by Table 3. VM₁ has used 10% or 2 Gbps of load balancing services, and VM₂ has used 4% or 0.8 Gbps of load balancing services. The load balancing costs are allocated using the implementation previously described. VM₁ is allocated $8 of cost (%10 of $80), and VM₂ is allocated $3.20 of cost (%4 of $80). $68.80 of cost is unallocated because VM₁ and VM₂ did not use %86 of the available firewall capacity.

TABLE 3
Accumulation and Allocation of Network Service Costs

| Service Type | |
|---|---|
| Load Balancing | |
| Network Service Capacity | |
| Load Balancing Capacity | 20 Gbps |
| Service Costs | |
| Load Balancing Cost | $80.00 |

| Load Balancing Service Utilization of each VM | Percentage | Usage |
|---|---|---|
| VM₁ | 10.00% | 2 Gbps |
| VM₂ | 4.00% | 0.8 Gbps |

| Allocation of Load Balancing Service Costs | |
|---|---|
| VM₁ | $8.00 |
| VM₂ | $3.20 |
| Unallocated | $68.80 |

Table 4 displays the total costs allocated to VM₁ and VM₂, as well as the unallocated costs associated with the virtual network. The total costs allocated to each virtual machine include common costs, and costs associated with providing specific network services. The remaining costs are unallocated.

TABLE 4
Allocated Virtual Networking Costs are the Sum of Common
costs and Service Costs

| | Common | Firewall | Load Balancing | Subtotal |
|---|---|---|---|---|
| VM₁ | $40.00 | $6.00 | $8.00 | $54.00 |
| VM₂ | $60.00 | $4.00 | $3.20 | $67.20 |
| Unallocated | $100.00 | $10.00 | $68.80 | $178.80 |
| | | | Total Allocated: | $121.20 |

The cost accounting and allocation process described above can be applied to improve the operation of the virtual network. In one implementation, the maximum ratio of unallocated costs to total costs is 0.8, and the minimum ratio of allocated costs to unallocated costs is 0.2. In the example above, the ratio of unallocated costs to total costs is 0.404 ($121.20/$300). Since this is between minimum and maximum ratios, the amount of overall resources for the virtual network is acceptable. In some implementations, the resource adjustment occurs on a per-service basis. For example, a load-balancing ratio of unallocated load balancing resources to total load-balancing resources is 0.86 ($68.80/$80.00). Since load-balancing ratio exceeds the maximum ratio of unallocated costs of 0.8, resources associated with providing the load balancing network service are reduced. Resources associated with specific services can be increased or decreased when their respective unallocated to total cost ratios leave the defined minimum-maximum range. In some implementations, each network service defines a maximum and a minimum unallocated-to-total-cost ratio that is adapted to the operational characteristics of each service.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method that allocates virtual network costs to data center tenants, the method comprising:
determining a virtual network cost of a virtual network;
determining a capacity of the virtual network; and
allocating a portion of the virtual network cost based on a measured usage of the virtual network by a data center tenant's network client devices and the capacity of the virtual network.

2. The method of claim 1 wherein determining the virtual network cost includes:
determining a common cost of the virtual network; and
determining a service cost of one or more network services that is provided by the virtual network.

3. The method of claim 2 wherein determining the capacity of the virtual network further comprises:
determining a network bandwidth of the virtual network; and
determining a service capacity for each of the one or more network services.

4. The method of claim 3 wherein allocating the portion of the cost to the network client device further comprises:
allocating a first portion of the common cost to the network client device based on a proportion of network bandwidth used by the network client device; and
allocating a second portion of cost of one or more network services to the network client device based on a percentage of the service capacity used by the network client device.

5. The method of claim 1 further comprising:
determining an unallocated cost of the virtual network.

6. The method of claim 5 further comprising:
determining a ratio of the unallocated cost to a corresponding total cost;
increasing resources allocated to the virtual network when the ratio exceeds a maximum threshold; and
decreasing the resources allocated to the virtual network when the ratio is less than a minimum threshold.

7. The method of claim 3 wherein determining the network bandwidth of the virtual network is accomplished by:
determining the bandwidth of each network segment of the virtual network; and
selecting a maximum bandwidth from the determined bandwidths.

8. The method of claim 7 wherein each network segment is isolated by an OSI level-3 router.

9. The method of claim 2 wherein the one or more network services includes at least one of:
a DHCP service,
a firewall service,
a load balancing service,
a NAT service, and
a VPN service.

10. The method of claim 2 wherein determining the common cost further comprises:
determining a first cost of level-2 switching services; and
determining a second cost of level-3 routing services.

11. A computer-readable medium encoded with machine-readable instructions that implement a method carried out by one or more processors of a computer system to perform the operations of:
determining a virtual network cost of a virtual network;
determining a capacity of the virtual network; and
allocating a portion of the virtual network cost based on a measured usage of the virtual network by a data center tenant's network client device and the capacity of the virtual network.

12. The physical computer-readable media of claim 11 wherein determining the virtual network cost includes:
determining a common cost of the virtual network; and
determining a service cost of one or more network services that is provided by the virtual network.

13. The physical computer-readable media of claim 12 wherein determining the capacity of the virtual network further comprises:
determining a network bandwidth of the virtual network; and
determining a service capacity for each of the one or more network services.

14. The physical computer-readable media of claim 13 wherein allocating the portion of the cost to the network client device further comprises:
allocating a first portion of the common cost to the network client device based on a proportion of network bandwidth used by the network client device; and
allocating a second portion of the cost of one or more network services to the network client device based on a percentage of the service capacity used by the network client device.

15. The physical computer-readable media of claim 11 further comprises:
determining an unallocated cost that is of the virtual network.

16. The physical computer-readable media of claim 15 further comprises:
determining a ratio of the unallocated cost to a corresponding total cost;
increasing resources allocated to the virtual network when the ratio exceeds a maximum threshold; and
decreasing the resources allocated to the virtual network when the ratio is less than a minimum threshold.

17. The physical computer-readable media of claim 13 wherein determining the network bandwidth of the virtual network further comprises:
determining the bandwidth of each network segment of the virtual network; and
selecting a maximum bandwidth from the determined bandwidths.

18. The physical computer-readable media of claim 17 wherein each network segment is isolated by an OSI level-3 router.

19. The physical computer-readable media of claim 12 wherein the one or more network services includes at least one of:
a DHCP service,
a firewall service,
a load balancing service,
a NAT service, and
a VPN service.

20. The physical computer-readable media of claim 12 wherein determining the common cost further comprises:
determining a first cost of level-2 switching services; and
determining a second cost of level-3 routing services.

21. A system for adjusting a hard threshold comprising:
one or more processors;
one or more data-storage devices; and
a routine stored in the data-storage devices and executed using the one or more processors, the routine:
determining a virtual network cost of a virtual network;
determining a capacity of the virtual network; and
allocating a portion of the virtual network cost based on a measured usage of the virtual network by a data center tenant's network client device and the capacity of the virtual network.

22. The system of claim 21 wherein determining the virtual network cost includes:
determining a common cost of the virtual network; and
determining a service cost of one or more network services that is provided by the virtual network.

23. The system of claim 22 wherein determining the capacity of the virtual network further comprises:
determining a network bandwidth of the virtual network; and
determining a service capacity for each of the one or more network services.

24. The system of claim 23 wherein allocating the portion of the cost to the network client device further comprises:
allocating a first portion of the common cost to the network client device based on a proportion of network bandwidth used by the network client device; and
allocating a second portion of cost of one or more network services to the network client device based on a percentage of the service capacity used by the network client device.

25. The system of claim 21 further comprising:
determining an unallocated cost of the virtual network.

26. The system of claim 25 further comprising:
determining a ratio of the unallocated cost to a corresponding total cost;
increasing resources allocated to the virtual network when the ratio exceeds a maximum threshold; and
decreasing the resources allocated to the virtual network when the ratio is less than a minimum threshold.

27. The system of claim 23 wherein determining the network bandwidth of the virtual network is accomplished by:
determining the bandwidth of each network segment of the virtual network; and
selecting a maximum bandwidth from the determined bandwidths.

28. The method of claim 27 wherein each network segment is isolated by an OSI level-3 router.

29. The system of claim 22 wherein the one or more network services includes at least one of:
a DHCP service,
a firewall service,
a load balancing service,
a NAT service, and
a VPN service.

30. The system of claim 22 wherein determining the common cost further comprises:
determining a first cost of level-2 switching services; and
determining a second cost of level-3 routing services.
